(19) United States
(12) Patent Application Publication
(10) Pub. No.: US 2004/0212987 A1
(43) Pub. Date: Oct. 28, 2004

(54) Illuminant design device

(76) Inventor: Chia-Ping Lu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/760,415

(22) Filed: Jan. 21, 2004

(30) Foreign Application Priority Data
Jan. 21, 2003 (TW) 092201053

(51) Int. Cl. F21V 33/00

(52) U.S. Cl. 362/101; 362/104; 362/154

(57) ABSTRACT

An illuminating design housing which may be transparent or semi-transparent is provided wherein a lamp bulb is located at a lower portion of the housing and emits projected light through the housing to provide visual effects and permits location of objects contained within the housing.

### SUMMARY

This invention is an illuminant design device including a design device body, transparent or semi-transparent, a battery container on the side, a battery plug under the battery container with positive and negative points, and a battery inside the battery plug. The battery should be connected to the lamp bulb. When the electricity is on, the lamp bulb, located above the battery container or inside the device, emits the projected light to the device necessary to give viewers sensual feelings. Moreover, The exhibit can also be put onto the design device.

### TECHNOLOGY

This invention is an illuminant design device, functional and ornamental, that can be either a design device or an object to display an exhibit.

### DESCRIPTION OF RELATED ART

With the improvement of living standards, people have greater expectations for their personal artifacts nowadays. Daily goods like brush pots, name card boxes, jewelry boxes, or gift boxes are expected to be functional and beautiful. However, the surface of those goods, plated or polished, can only be visible in the light. Therefore, we have been always working on how to create an illuminant design device to enhance ornamental and practical functions. This invention, the solution to the problems, has been designed based on our valuable experiences in the aspects of research, development, and marketing.

### SUMMARY OF THE INVENTION

The primary objective of this invention is to create an illuminant design device to enhance the ornamental functions of our daily goods.

The secondary objective of this invention is to create an illuminant design device to display the personal artifact to enhance their ornamental and practical functions. To achieve the above objectives, we have created an illuminant design device including a design device body, transparent or semi-transparent, a battery container at one side of the device, a battery plug under the battery container with positive and negative points, and a battery inside the battery plug. The battery should be connected to the lamp bulb. The device itself can be an ordinary brush pot, jewelry box, gift box, name card box and so on. The device itself should have the capacity for at least one exhibit such as a mineral, watch, jewelry, and gift, goods, glassware, picture, etc. . . . . The exhibit can be solid, liquid, or the mixture of solid and liquid. The exhibit may be audible and flavored. The exhibit can be sealed inside of the design device or be regarded as one unit with the design device. The exhibit can be capped or uncapped inside of the design device. The design device can be set on any kind of surface, suspended, or soaked in the liquid partly or completely.

To further illustrate this invention and its functions, the detailed specifications and descriptions are as follows:

### BRIEF DESCRIPTION OF THE DRAWINGS

FIG. 1 shows the three-dimensional picture of this invention.

FIG. 2 shows the perspective picture of this invention.

FIG. 3 shows one three-dimensional picture of the application of this invention.

FIG. 4 shows another three-dimensional picture of the application of this invention.

### SYMBOLS DESCRIPTION

10 The brush pot

12 The battery container

14 The battery plug

16 The positive point

18 The negative point

20 The battery

22 The lamp bulb

24 The positive conducting wire

26 The negative conducting wire

28 The timing device

30 The stationery

32 The mineral

40 The paperweight

### DESCRIPTION OF THE PREFERRED EMBODIMENTS

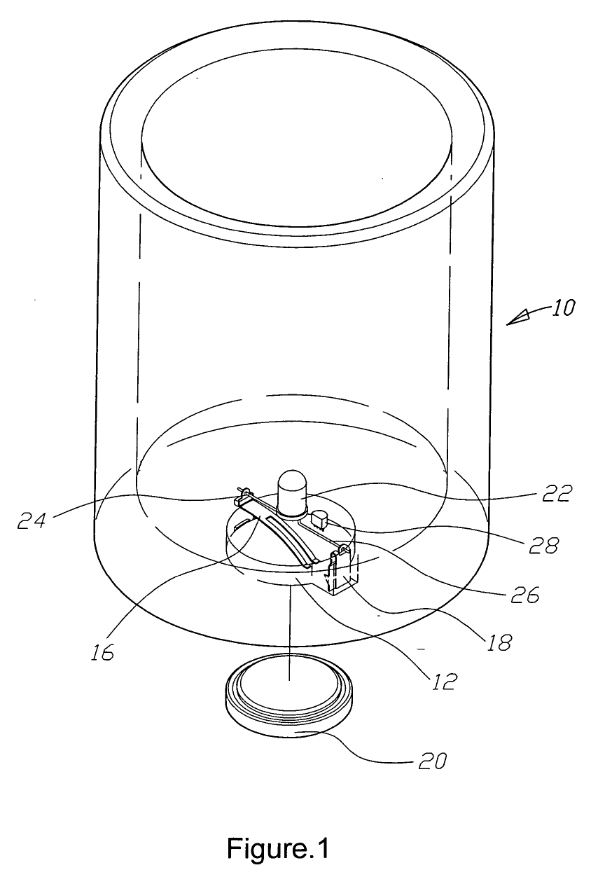

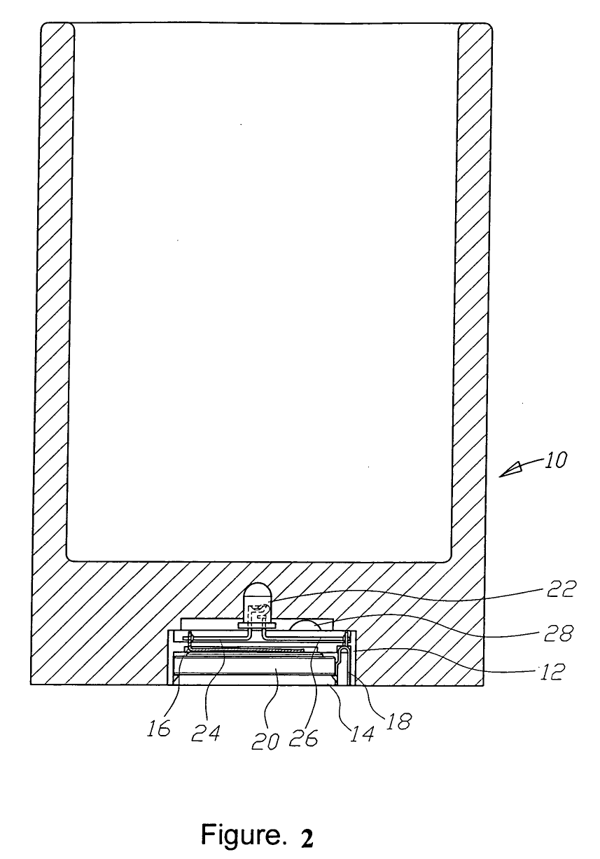

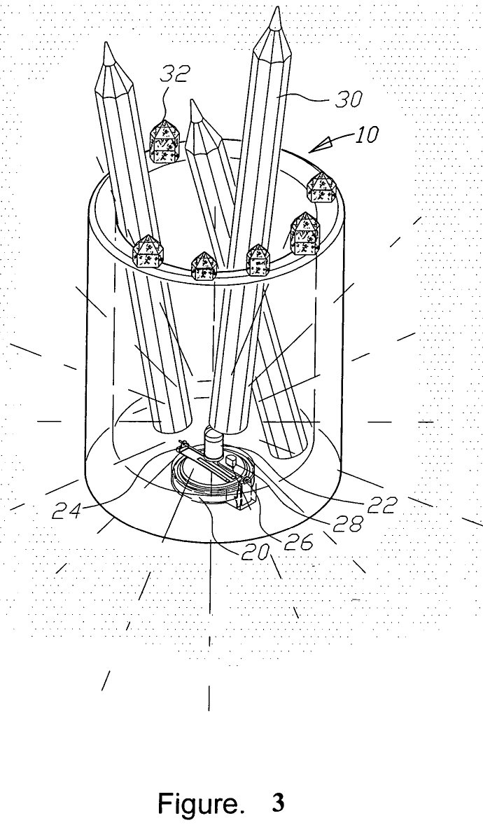

Referring to FIG. 1, the three-dimensional picture of this invention, and the FIG. 2, the perspective picture of this invention. As shown in the drawings, this design device has a brush pot 10. The battery container 12 is under the brush pot 10. The battery plug 14, under the battery container 12, has a cathode 16, an anode 18, and a battery 20 inside. The battery 20 is connected to the cathode 16 and the anode 18. The lamp 22, on the top of battery plug 14, has at least one LED inside. The lamp 22 is connected to positive conducting wire 24 and negative conducting wire 26. Since the positive conducting wire 24 and the negative conducting wire 26 is connected to the positive point 16 and the negative point 18 each, the lamp 22 is electrically connected to the battery 20. The timing device 28, inside of the battery plug 14, is electrically connected to the lamp 22 as well. The battery container 12 has an electricity plug. Please refer to FIG. 3, one three-dimensional picture of the application of this invention. As shown in the drawing, the design device, holding the stationery 30, can be a brush pot 10. The lamp bulb 22 of the brush pot 10 is electronically connected to the battery 20 through the positive conducting wire 24 and the negative conducting wire 26. The lamp 22 can emit the projected lights to the brush pot 10, transparent or semi-transparent, and thus create an ornamental function. The brush pot can not only hold stationery 30 but also decorate the environment. When the lamp 22 emits light, the timing device 28 will time and the lamp 22 will emit another color of light after a certain period of time. The timing device can be directly packaged into the lamp 22. The brush pot 10 can display at least one exhibit. The exhibit can be a watch or the mineral 32 such as natural gem, artificial gem, and semi-gem, crystal, amber, colored glaze, and transparent and semi-transparent mineral. The projected lights from the lamp 22 through the mineral 32 will be deflected and thus have more colorful and brilliant lights. This enhances the ornamental function of the brush pot 10.

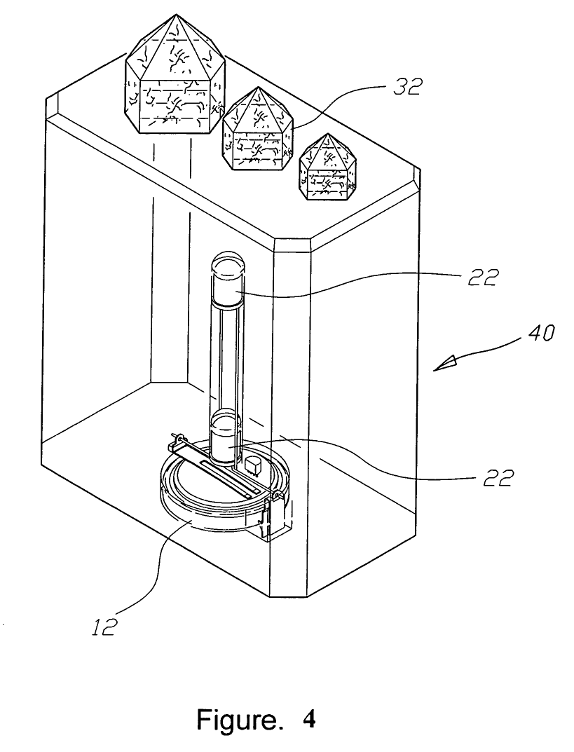

Referring to FIG. 4, another three-dimensional picture of the application of this invention. Different from FIG. 3, the design device here is the paperweight 40. The lamp 22, above the battery container 12 (that is at the bottom of the paperweight 40) and on the upper side of the paperweight 40, will emit lights to the paperweight 40 and the mineral 32 to enhance their ornamental functions. Several sets of battery containers 12 and lamps 12 can be put into the design device to improve the brightness. The battery container 12 can have an electric plug.

To sum up, this Illuminant Design Device is designed to serve any personal artifact, it can be decorated by the projected lights from the lamp 22, and can display other exhibits as well. The device can be united with other designs like a brush pot or name card box. Therefore, this invention is definitely profitable and state-of-the-art. It is in conformity with the regulations of the patent laws. Your prompt approval of the patent application will be highly appreciated.

The contents of the patent application should not be limited to the above-mentioned application examples. Instead, any shape, structure, or character of this invention should be regarded as the contents of the patent application.

1 An illuminant design device, including:
a design device body being transparent or semi-transparent;
a battery container located on a side of the design device;
a battery plug with cathode and anode points at the bottom of the battery container; and
a battery inserted into the battery plug and electronically connected to at least one LED.

2 The illuminant design device as recited in claim 1 where the device has mounted thereon at least one exhibit.

3 The illuminant design device as recited in claim 2 where the said exhibit includes an object chosen from the group of jewelry, gift, artifact, glassware, picture, and a mineral, wherein the mineral includes natural, artificial, semi-gem, natural and human-made crystal, amber, colored glaze, transparent and semi-transparent minerals.

4 The illuminant design device as recited in claim 3 where the exhibit can be audible or not, flavored or not, solid, liquid or the mixture of solid and liquid.

5 The illuminant design device as recited in claim 1 where the said exhibit is sealed inside the design device or integrally formed with design device.

6 The illuminant design device as recited in claim 2 where the said exhibit is set on any kind of surface, suspended, or soaked in liquid partially or completely.

7 The illuminant design device as recited in claim 1 where the battery container has a timing device electronically connected to the LED lamp bulb.

8 The illuminant design device as recited in claim 1 where the LED lamp bulb has a timing device inside electronically connected to the LED lamp bulb.

9 The illuminant design device as recited in claim 1 where the design device includes at least one LED.

10 The illuminant design device as recited in claim 1 where the battery container is formed in one unit with the design device.

11 The illuminant design device as recited in claim 1 where the design device may be formed in a varying shape.

12 The illuminant design device as recited in claim 1 where the design device has varying designs formed thereon.

13 (canceled).

14 The illuminant design device as recited in claim 1 where the battery container has at least one electricity plug.
